(19) United States
(12) Patent Application Publication
(10) Pub. No.: US 2010/0160003 A1
(43) Pub. Date: Jun. 24, 2010

(54) METHOD AND SYSTEM FOR CONTROLLING PORTABLE PHONE ACCORDING TO SIGNAL INTENSITY

(75) Inventors: CHUN-KEONG CHEW, Tu-Cheng (TW); YI-FANG WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/470,933

(22) Filed: May 22, 2009

(30) Foreign Application Priority Data
Dec. 19, 2008 (CN) 200810306397.1

(51) Int. Cl. H04B 1/38

(52) U.S. Cl. 455/574

(57) ABSTRACT

A system and method is used to control a portable phone according to signal intensity. The system includes a measurement module, a comparison module, and a switch module. The measurement module is capable of measuring an intensity of the signal which the portable phone receives. The comparison module is connected to the measurement module capable of receiving the measured intensity from the measurement module, and compares the measured intensity with a threshold intensity that is stored in the comparison module, and generates a comparison result. The switch module is connected to the comparison module and capable of receiving the comparison result form the comparison module. The switch module stores a plurality of work states of the portable phone, and switches the portable phone to work in a corresponding work state according to the comparison result.

### BACKGROUND

1. Technical Field

The disclosure relates to communications technology, and particularly to control the portable phone according to signal intensity.

2. Description of Related Art

A driving source to operate a portable phone circuit is typically a battery. There is a limit to the capacity of the battery, and thus, the power consumption of the portable phone as little as possible. Also, the power consumption at the time of transmission and reception is high especially when a signal intensity of the portable phone receiving is low. Also when having to have a high transmission, the portable phone puts forth the most radiation, which may have an influence on the user's health. Many users do not know when their phone or portable device is producing high levels of radiation when the portable phones have a low intensity signal.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a first embodiment of a block diagram of a system for controlling mobile phone according to signal intensity;

FIG. 2 is a second embodiment of a block diagram of a system for controlling mobile phone according to signal intensity; and

FIG. 3 is a flowchart of a method for controlling mobile phone according to signal intensity.

### DETAILED DESCRIPTION

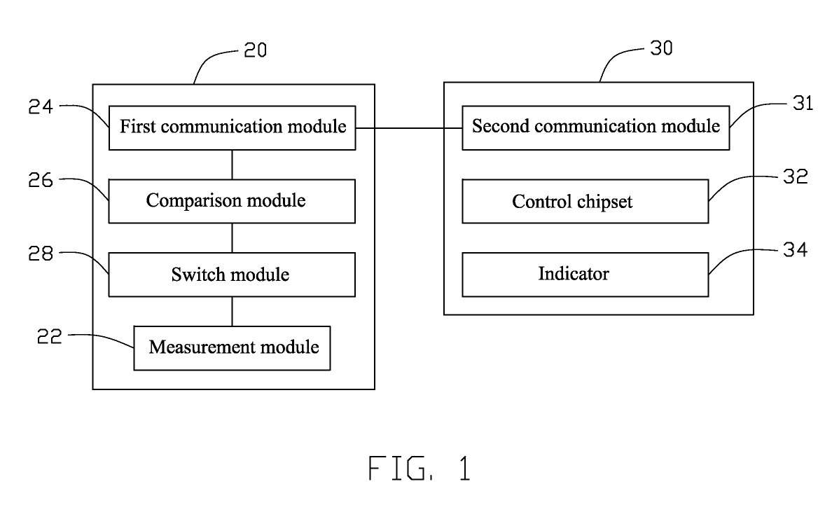

Referring to FIG. 1, an system for controlling a portable phone 20 according to signal intensity includes a measurement module 22, a first communication module 24, a comparison module 26, a switch module 28, and an indicating apparatus 30. The system can reside completely in the portable phone 20, or partly in the portable phone 20, or outside the portable phone 20. In the present embodiment, the indicator apparatus 30 of the system is outside the portable phone 20, and other parts of the system reside in the portable phone 20.

The measurement module 22 is used to measure the intensity of the signal that the portable phone 20 receives. The comparison module 26 is connected to the measurement module 22. A threshold intensity can be pre-established in the comparison module 26. The comparison module 26 compares the intensity of the signal with the threshold intensity. The switch module 28 is connected to the comparison module 26 for receiving a comparison result from the comparison module 26. The switch module 26 can store a plurality of defined work states of the portable phone 20 corresponding to different comparison results. The switch module 26 is capable of switching the portable phone 20 to work in corresponding work states according to the comparison result. For example, when the measured intensity is larger than the threshold intensity, the switch module 26 switches the portable phone 20 to work in a first state, such as a normal use state. When the measured intensity is smaller than the threshold intensity, the switch module 26 switches the portable phone 20 to work in a second state, such as an idle state in which the portable phone 20 locked from use, or an alarm state in which the user is alerted there is a low signal intensity condition when he uses the portable phone 20. The first communication module 24 is connected to comparison module 26 and the indicating apparatus 30 for sending the comparison result to the indicating apparatus 30.

The indicating apparatus 30 includes a second communication module 31, a control chipset 32, and an indicator 34. The second communication module 31 is connected to the first communication module 24. The control chipset 32 is used to control the indicator 24 to indicate different states of the portable phone 20 according to the comparison result.

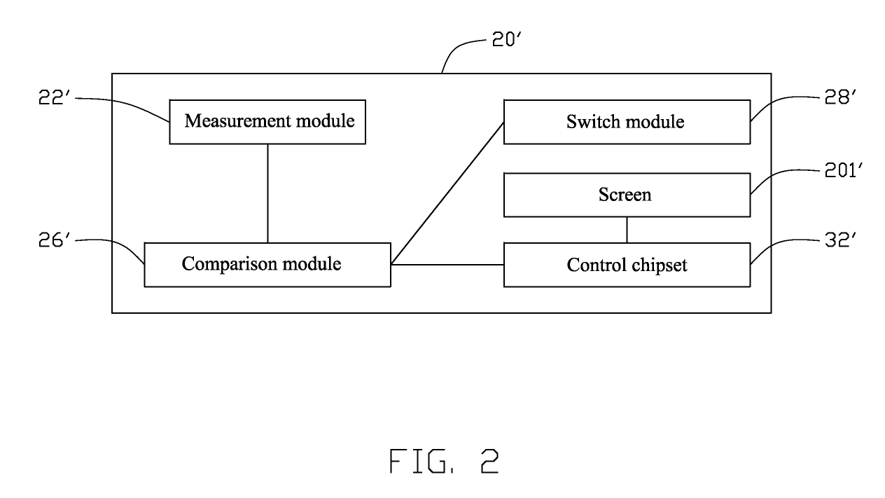

Referring to FIG. 2, a second embodiment of the system is disclosed. In the second embodiment, all of the system resides in the portable phone 20′. The portable phone 20′ has a screen 201′. The system includes a measurement module 22′, a comparison module 26′, a switch module 28, and a control chipset 32′. The comparison module 26′ is connected to the measurement module 22′, a switch module 28′, and the control chipset 32′. The control chipset 32′ is connected to the screen 201′.

The measurement module 22′ measures an intensity of the signals that the portable phone 20′ receives. The comparison module 26′ compares the intensity of the signal with one or more threshold intensities stored in the comparison module 26′, and provides a measure result. The switch module 28′ stores a plurality of work states of the portable phone 20′ corresponding to different comparison results. The switch module 28′ is capable of switching the portable phone 20′ to work in a work state according to the comparison result. The control chipset 32′ controls the screen 201 to show corresponding information according to the measure result.

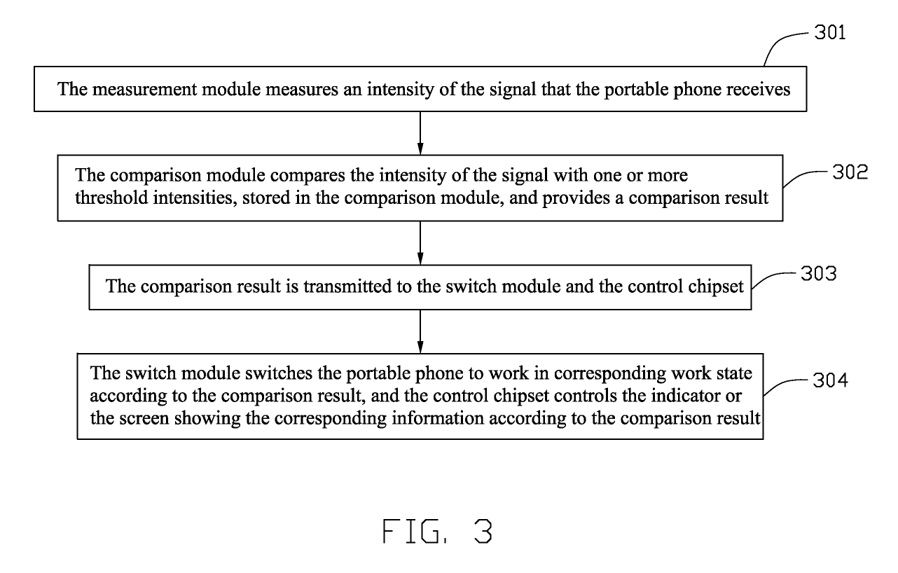

Referring to FIG. 3, a method of control mobile phone according to signal intensity includes the following steps:

In step 301, the measurement module 22 or 22′ measures an intensity of the signal that the portable phone 20′ receives.

In step 302, the comparison module 26 or 26′ compares the intensity of the signal with one or more threshold intensities, stored in the comparison module 26 or 26′, and provides a comparison result.

In step 303, the comparison result is transmitted to the switch module 28 or 28′ and the control chipset 32 or 32′. In the first embodiment of the system, the measure result is transmitted to the control chipset 32 via the first and second communication modules 24, 31. In the second embodiment, the measure result is transmitted from the comparison module 26′ to the control chipset 32′ directly.

In step 304, the switch module 28 or 28′ switches the portable phone 20 or 20′ to work in a corresponding work state according to the comparison result, and the control chipset 32 or 32′ controls the indicator 34 or the screen 201 to show the corresponding information according to the comparison result. The indicator 34 can light in different manners to indicate different information. For example, when the measured intensity is larger than the threshold intensity, the portable phone 20 or 20′ is switched to work in the first state, and the indicator 34 lights up green, or the screen 201 shows “normal” thereon. When the measured intensity is smaller larger than the threshold intensity, the portable phone 20 or 20′ is switched to work in the second state, and the indicator 34 lights red, or the screen 201 shows “low intensity” thereon.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A system for controlling a portable phone according to signal intensity, the system comprising:
a measurement module capable of measuring an intensity of the signal which the portable phone receives;
a comparison module connected to the measurement module capable of receiving the measured intensity from the measurement module, comparing the measured intensity with a threshold intensity that is stored in the comparison module, and generating a comparison result; and
a switch module connected to the comparison module and capable of receiving the comparison result form the comparison module, storing a plurality of work states of the portable phone, and switching the portable phone to work in a corresponding work state according to the comparison result.

2. The system of claim 1, wherein the plurality of work states of the portable phone includes a normal work state in which the portable phone can be used when the measured intensity is larger than the threshold intensity, and an idle state in which the portable phone is locked from use when the measured intensity is less than the threshold intensity.

3. The system of claim 1, wherein the plurality of work states of the portable phone includes a normal work state in which the portable phone can be used when the measured intensity is larger than the threshold intensity, and an alarm state in which the alarm is activated to indicate a low signal intensity when the measured intensity is smaller than the threshold intensity.

4. The system of claim 1, further comprising an indicating apparatus, the switching module further comprises a control chipset and an indicator, the control chipset is capable of controlling the indicator to show information according to the comparison result.

5. The system of claim 4, wherein the indicator lights in different manners when the measured intensity is larger or smaller than the threshold intensity.

6. The system of claim 4, wherein the measurement module, the comparison module, and the switch module resides in the portable phone; the indicating apparatus is exposed to the environment; the system further comprises a first communication module that resides in the portable phone, and a second communication module resides in the indicating apparatus, whereby the first communication module communicates with the second communication module to transmit the comparison result from the comparison module to the controlling chipset.

7. The system of claim 1, further comprising a control chipset, the control chipset connected to a screen of the portable phone and capable of causing the screen to show corresponding information according to the comparison result.

8. The system of claim 7, wherein the screen is capable of showing an indication of the work state.

9. A method for controlling a portable phone according to signal intensity, the method comprising:
providing a measurement module and a comparison module;
measuring an intensity of the signal that the portable phone receives;
comparing the intensity of the signal with a threshold intensity which is stored in the comparison module, and acquiring a comparison result;
transmitting the comparison result to a switch module; and
switching the portable phone to work in corresponding work state according to the comparison result.

10. The method of claim 9, wherein when the measured intensity is larger than the threshold intensity, the portable phone is to work in a normal work state in which the portable phone can be used; and when the measured intensity is smaller than the threshold intensity, the portable phone is switch to work in an idle state in which the portable phone is locked from use.

11. The method of claim 9, wherein when the measured intensity is larger than the threshold intensity, the portable phone works in a normal work state in which the portable phone can be used, and when the measured intensity is smaller than the threshold intensity, the portable phone works in an alarm state in which an alarm is activated.

12. The method of claim 9, wherein when the measured intensity is larger than the threshold intensity, a control chipset controls an indicator light to display one color, and when the measured intensity is smaller than the threshold intensity, the control chipset controls the indicator light to display another color.

13. The method of claim 9, wherein a screen of the mobile phone shows an indication of the work state.
